(19) United States
(12) Patent Application Publication
(10) Pub. No.: US 2018/0122134 A1
(43) Pub. Date: May 3, 2018

(54) THREE-DIMENSIONAL MODEL CONSTRUCTION SYSTEM AND THREE-DIMENSIONAL MODEL CONSTRUCTION METHOD

(71) Applicant: HTC Corporation, Taoyuan City (TW)

(72) Inventor: Lun-Kang LIN, TAOYUAN CITY (TW)

(21) Appl. No.: 15/342,101

(22) Filed: Nov. 2, 2016

(51) Int. Cl. G06T 17/00; G01P 15/08; G01C 19/00; G01C 21/08

(52) U.S. Cl. CPC G06T 17/00; G01C 21/08; G01C 19/00; G01P 15/0802

(57) ABSTRACT

The invention provides a three-dimensional model construction system and a three-dimensional model construction method. The three-dimensional model construction system includes a first sensor hub and first sub sensor. The first sensor hub is placed at a first part of a body for transmitting a first detecting signal. The first sub sensor is placed at a second part of the body for transmitting a second detecting signal back to the first sensor hub in response to receiving the first detecting signal from the first sensor hub. The first sensor hub records a first round trip time of the first detecting signal and the second detecting signal, and the first round trip time is applied to calculate a length between the first part of the body and the second part of the body for constructing a three-dimensional body model.

### BACKGROUND

### Field of Invention

The present invention relates to a three-dimensional model construction system and a three-dimensional model construction method. More particularly, the present invention relates to a three-dimensional model construction system and a three-dimensional model construction method to construct a three-dimensional human body image.

### Description of Related Art

The systems of generating motion capture are becoming increasingly popular. Motion capture system can be applied for movies, virtual reality, or other augmented reality applications. In general, the motion capture system can be distinguished into the optical and the inertial sensor based system. For the sensor based systems, we have to construct the user's 3D model before capture his/her movement. Because an inaccurate human geometry will have huge effect on motion capture result.

The optical motion capture system uses the multiple high-speed cameras to capture the markers that attached on human body for constructing a three-dimensional body model. It's pretty straight forward and easy in model construction. However, the optical motion capture system needs a space to configure these high-speed cameras. As such, the movement of the human body may be limited by the size of the space. And, the optical motion capture system needs the higher cost for constructing the environment for capturing the human body.

On the other hand, the sensor based motion capture system can be used in any environment without limitation and also have advantage in cost. This system can be realized by placing multiple sensors on the different parts of the human body. But, before we start to capture movement, it need to be input the length of each body part (hand, leg, trunk . . . ) by manually measurement for construct 3D model.

Therefore it is a problem desired to be solved in the industry sensor based motion capture system that is how to construct a 3D human model without manually measurement.

### SUMMARY

The invention provides a three-dimensional model construction system. The three-dimensional model construction system includes a first sensor hub and first sub sensor. The first sensor hub is placed at a first part of a body for transmitting a first detecting signal. The first sub sensor is placed at a second part of the body for transmitting the second detecting signal back to the first sensor hub in response to receiving the first detecting signal from the first sensor hub. Wherein the first sensor hub records a first round trip time of the first detecting signal and the second detecting signal, and the first round trip time is applied to calculate a length between the first part of the body and the second part of the body for constructing a three-dimensional body model

On another aspect, the invention provides a three-dimensional model construction method. The three-dimensional model construction method includes following steps: transmitting a first detecting signal by a first sensor hub placed at a first part of a body; and transmitting a second detecting signal back to the first sensor hub in response to receiving the first detecting signal from the first sensor hub by a first sub sensor placed at a second part of the body; wherein the first sensor hub records a first round trip time of the first detecting signal and the second detecting signal, and the first round trip time is applied to calculate a length between the first part of the body and the second part of the body for constructing a three-dimensional body model.

Through the three-dimensional model construction system and three-dimensional model construction method, the lengths of user's limbs can be precisely calculated for constructing the three-dimensional body model. And, the sensor hubs of the three-dimensional model construction system directly transmit information to the other electronic device. The sensor hubs do not need to connect to each other, In this way, the movement of the human body and the size of human body will not be limited by the wires or transmission issue between the sensor hubs. Besides, the sensor hubs and the sub sensors can be configured in a suit. It helps users having different body shapes can easily wear the suit to construct the three-dimensional model. Therefore, the present invention provides a three-dimensional model construction system and method for precisely detecting the length of different parts of the human body, so as to construct the three-dimensional body model.

### BRIEF DESCRIPTION OF THE DRAWINGS

The invention can be more fully understood by reading the following detailed description of the embodiment, with reference made to the accompanying drawings as follows:

FIG. 1A illustrates a schematic diagram of a three-dimensional model construction system according to an embodiment of the present invention;

FIG. 1B illustrates a block diagram of a sensor hub according to an embodiment of the present invention;

FIG. 2 illustrates a schematic diagram of a three-dimensional model construction system according to an embodiment of the present invention;

FIG. 3 illustrates a schematic diagram of a usage scenario of the three-dimensional model construction system according to an embodiment of the present invention; and

FIG. 4 illustrates a three-dimensional model construction method 300 according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

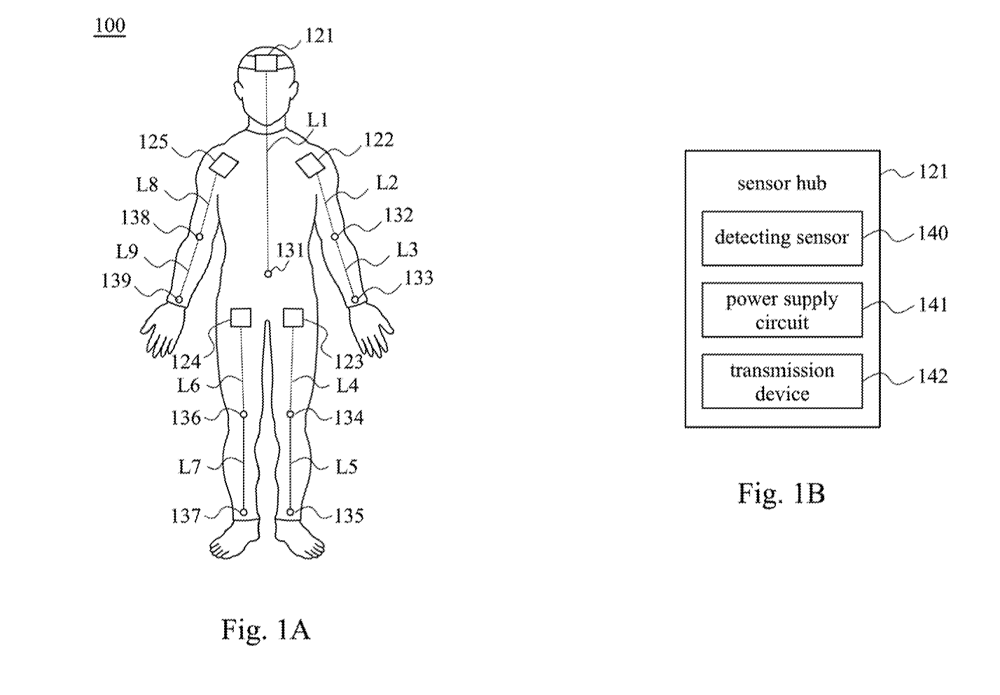

Reference is made to FIGS. 1A-1B. FIG. 1A illustrates a schematic diagram of a three-dimensional model construction system 100 according to an embodiment of the present invention. FIG. 1B illustrates a block diagram of a sensor hub 121 according to an embodiment of the present invention. As shown in FIG. 1A, the three-dimensional model construction system 100 includes sensor hubs 121-125 and sub sensors 131-139. As shown in FIG. 1B, the sensor hub 121 further includes a detecting sensor 140, a power supply circuit 141 and a transmission device 142. The detecting sensor 140 is used for detecting movement status (e.g. a movement speed or a position) of the first part of the body. In one embodiment, the detecting sensor 140 and the sub sensors 131-139 separately can be implemented as a nine-axis sensor, which includes multiple sub components, such as an accelerometer, a geomagnetic sensor, a transmitting module (e.g. Wi-Fi device, Bluetooth device) and/or the gyroscope. The power supply circuit 141 in the sensor hub 121 can be implemented as a battery. In one embodiment, the power supply circuit 141 is used for providing power to the sensor hub 121 and the sub sensor 131, which is coupled with the sensor hub 121. The transmission device 142 is used for transmitting and receiving the signals. In one embodiment, the transmission device 142 can be implemented as a network card (or Wi-Fi device, Bluetooth device) having the transmission function. In one embodiment, the sensor hubs 121-125 have the same physical structure, and the sub sensors 131-139 have the same physical structure.

In one embodiment, the sensor hub 121 can be placed at a first part of a body. For instance, the sensor hub 121 can be placed, touched or contacted (directly or indirectly) to the top of the head of a human body as shown in FIG. 1A. And, the sub sensor 131 can be placed at a second part of the body. For example, the sub sensor 131 can be placed, touched or contacted (directly or indirectly) to the backside or the abdomen of the human body. According to the relative position of the sub sensor 131 and the sensor hub 121, the sub sensor 131 and the sensor hub 121 can use for detecting whether the human body bend down or not. In one embodiment, the sensor hub 121 and the sub sensor 131 are connected by a wired connection.

In some embodiment, the sensor hub 122 placed at the left shoulder of the body, the sub sensor 132 placed at the left arm of the body, and the sub sensor 133 placed at the left wrist of the body. The sensor hub 122 and the sub sensors 132-133 are connected by a wired connection. However, in other embodiment, the sub sensor 131 also can be connected to the sensor hub 121 by the wireless connection such as wireless ad hoc network (WANET).

In one embodiment, the wire L1 is used for establishing a wired connection between the sensor hub 121 and the sub sensor 131 to form a first connection segment. The wires L2-L3 is used for separately establishing a wired connection to connect the sensor hub 122 and the sub sensors 132-133 to form a second connection segment. And, the first connection segment and the second connection segment are the different connection segments. In this way, the first connection segment and the second connection segment do not need to interact with or transmit signal to each other. That is, the sensor hubs 121-122 can separately transmit signals to the other electronic device (e.g. a server, a computer or a processor) by each one of themselves.

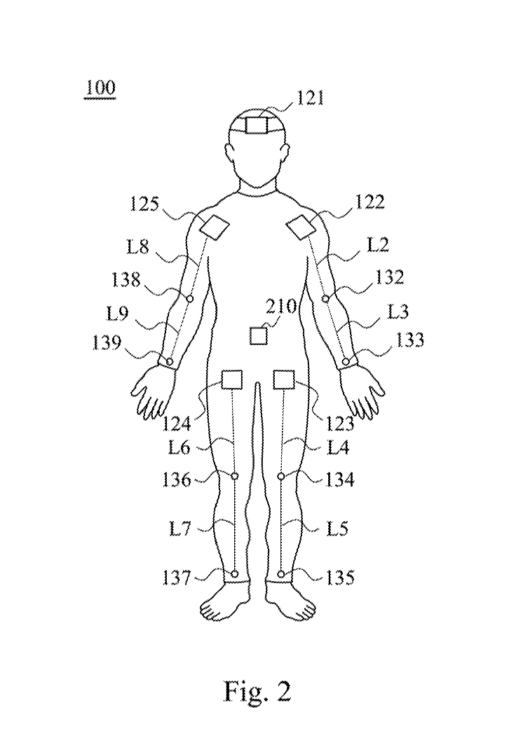

In other embodiment, the sub sensor 131 also can be replaced by the sensor hub, the invention is not limited thereto. Reference is made to FIG. 2, FIG. 2 illustrates a schematic diagram of a three-dimensional model construction system 200 according to an embodiment of the present invention. The difference between the three-dimensional model construction system 100 in FIG. 1 and the three-dimensional model construction system 200 in FIG. 2 is that the sub sensor 131 in FIG. 1 is replaced by the sensor hub 210 in FIG. 2. And, the wire L1 is removed in FIG. 2. In this way, the movement of the human body and the size of human body will not be limited by the wire L1.

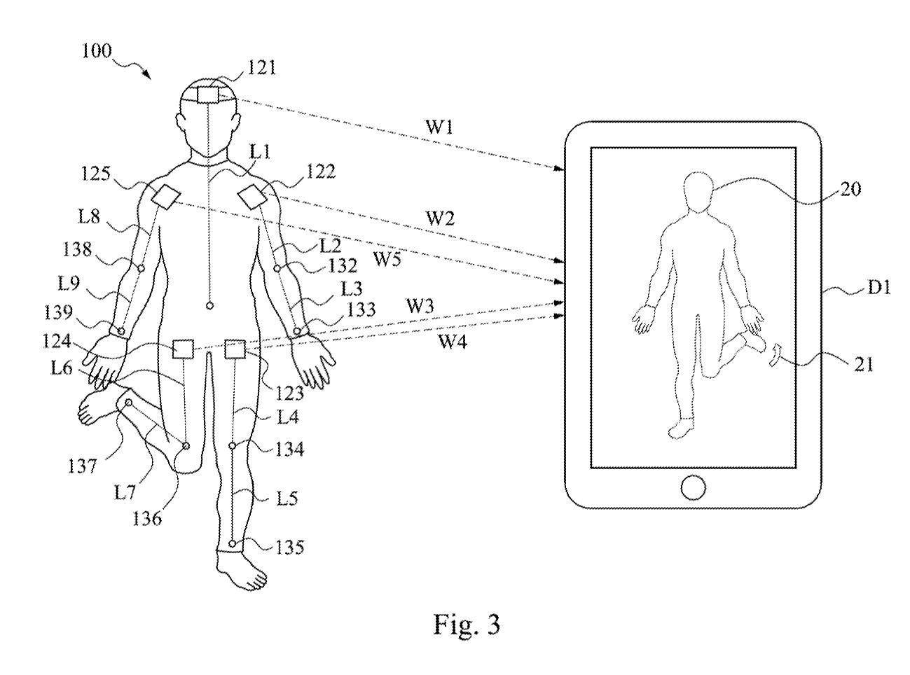

Similarly, the sensor hub 210 can be placed at the backside or the abdomen of the human body. The sensor hub 210 can detect whether the human body bend down or not. The sensor hub 210 also can directly transmit signals or information to the electronic device (e.g. electronic device D1 in FIG. 3). In some embodiments, the sensor hub 210 communicates to the sensor hubs 121-125 by wireless communication method. In some embodiment, the configuration of the sensor hubs 123-125 and the sub sensors 134-139 are similar to the configuration of the sensor hub 122 and sub sensors 132-133. Similarly, the sensor hubs 121-125 also can separately form different connection segments. For example, the sensor hub 124 and the sub sensors 136-137 are coupled by using the wires L6-L7 to form a connection segment, and the sensor hub 125 and the sub sensors 138-139 are coupled by using the wires L8-L9 to form another connection segment. It should be noticed that the sensor hubs 121-125 do not communicate to each other by wire or wireless communication method. These sensor hubs 121-125 can separately transmit signal to the other electronic device.

In other words, there is no need for the sensor hubs 121-125 to interact with each other. Each one of the sensor hubs 121-125 can directly transmit signals or information to the electronic device (e.g. electronic device D1 in FIG. 3). And then, the electronic device can generate a three-dimensional model according to the signals or information. Besides, other features of the sensor hubs 123-125 and the sub sensors 134-139 are similar to the sensor hub 122 and the sub sensors 132-133, as above mentioned. Therefore, the other features of the sensor hubs 123-125 and the sub sensors 134-139 are not redundantly mentioned herein.

Besides, it should be noticed that there are five sensor hubs 121-125 and nine sub sensors 131-139 shown in FIG. 1A. However, the number and the placement of the sensor hubs and sub sensors can be adjusted according to the practice implementation.

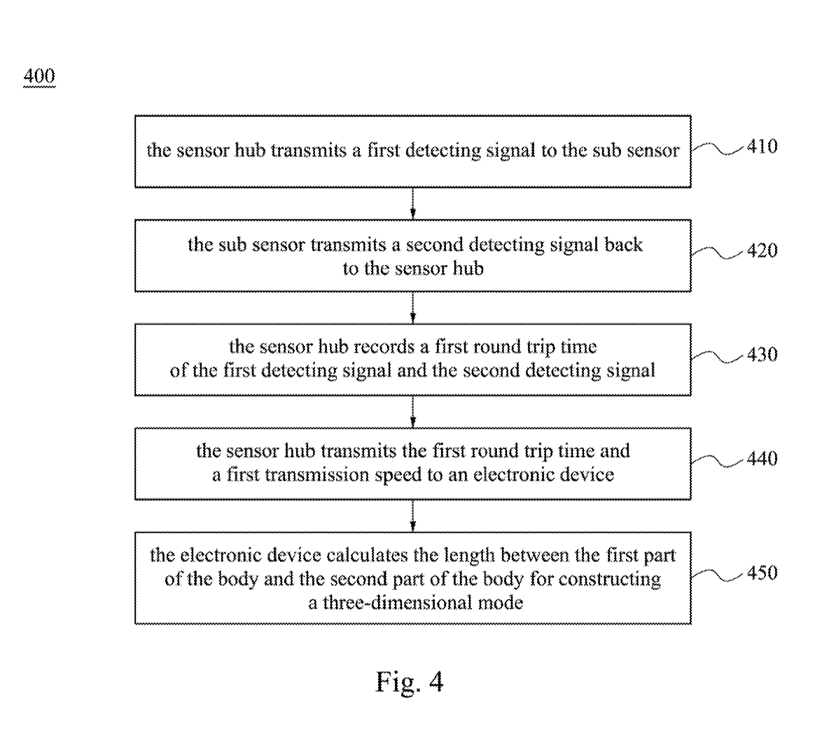

Reference is made to FIGS. 3-4. FIG. 3 illustrates a schematic diagram of a usage scenario of the three-dimensional model construction system 100 according to an embodiment of the present invention. FIG. 4 illustrates a three-dimensional model construction method 300 according to an embodiment of the present invention. In the following paragraphs, the three-dimensional model construction system 100 shown in FIGS. 1A-1B will be used as an example to describe the three-dimensional model construction method 400 shown in FIG. 4 according to the embodiment of the present disclosure.

In one embodiment, the sensor hubs 121-125 and sub sensors 131-139 can be tied on a human body by bandages. In another embodiment, the sensor hubs 121-125 and sub sensors 131-139 are included (or placed) in a wearable device or a suit. For instance, as shown in FIG. 3, the user can wear the suit to make the sensor hubs 121-125 and sub sensors 131-139 contact (directly or indirectly) to the user's body. After user wears or ties up the sensor hubs 121-125 and sub sensors 131-139 on user's body, the step 410 is performed.

In step 410, the sensor hub 121 transmits a first detecting signal to the sub sensor 131. In one embodiment, the transmission device 142 of the sensor hub 121 is used for transmitting the first detecting signal to the sub sensor 131.

Besides, the sub sensor 131 can be placed near the joint of the human body, without directly placing on the joint. It may avoid unnecessarily moving or shaking of the sub sensor 131 causing by the movement of the joint. In one embodiment, the sensor hub 122 also can transmit a second detecting signal to the sub sensor 132. In addition, the sub sensor 132 can be placed at the part of the human body (e.g. upper arm), which will have a relative movement corresponding to another part of the human body (e.g. shoulder) while another part of the human body is moving. It can help the three-dimensional model construction system 100 detect the movement and the limb lengths of the body more preciously.

In step 420, the sub sensor 131 transmits a second detecting signal back to the sensor hub 121 immediately after the sub sensor 131 receives the first detecting signal from the sensor hub 121. In this way, the sub sensor 131 can inform the sensor hub 121 that the sub sensor 131 has received the first detecting signal.

In step 430, the sensor hub 121 records a first round trip time of the first detecting signal and the second detecting signal. In one embodiment, the first round trip time can be applied to calculate a length between the first part of the body (e.g. head) and the second part of the body (e.g. backside) for constructing a three-dimensional body model.

In one embodiment, the sensor hub 121 adds a transmission time of transmitting the first detecting signal from the sensor hub 121 to the sub sensor 131 and a transmission time of transmitting the second detecting signal from the sub sensor 131 back to the sensor hub 121, so as to obtain the first round trip time. In some embodiment, the sensor hub 121 can record the time point of sending the first detecting signal and the time point of receiving the second detecting signal, so as to measure the first round trip time.

In step 440, the sensor hub 121 transmits the first round trip time and a first transmission speed to an electronic device D1. In one embodiment, the sensor hub 121 or the sub sensor 131 uses for determining or measuring the first transmission speed. The sensor hub 121 can collect the data related to the transmission speed and transmit the data to the electronic device D1. In one embodiment, the sensor hub 121 transmits the information of the first round trip time and a first transmission speed to an electronic device D1 by a wireless connection W1. The wireless connection W1 can be implemented by Wi-Fi, bluetooth, or other wireless communication method. In one embodiment, the electronic device D1 can be a smart phone, a computer or other device having computing function.

In step 450, a processor of the electronic device D1 calculates the length between the first part of the body and the second part of the body for constructing a three-dimensional model according to the first round trip time and the first transmission speed.

In one embodiment, the processor of the electronic device D1 multiplies the first round trip time by the first transmission speed to calculate the length between the first part of the body and the second part of the body. For instance, if the first round trip time is 0.3 seconds and the first transmission speed is 2 meters per second, the length between the first part of the body and the second part of the body is 0.3*2=0.6 meters (that is, 60 centimeters). Thus, the length between the first part of the body (e.g. head) and the second part of the body (e.g. backside) is 60 centimeters long.

Based on above, the length between the first part of the body (e.g. head) and the second part of the body (e.g. backside) for constructing a three-dimensional body model can be obtained. Similarly, the sensor hub 122 is placed at a third part of a body (e.g. left shoulder of the body). The sub sensor 132 is placed at a fourth part of the body (e.g. left upper arm of the body). The sensor hub 122 uses for transmitting a third detecting signal. And, the sub sensor 132 uses for transmitting a fourth detecting signal back to the sensor hub 122 after the sub sensor 132 receiving the third detecting signal sending from the sensor hub 122. According the same method, the sensor hub 122 transmits a second round trip time of the third detecting signal and the fourth detecting signal, and a second transmission speed of the second detecting signal, to the electronic device D1. Wherein, and the second round trip time is applied to calculate a length between the third part of the body and the fourth part of the body. To be more specificity, the processor of the electronic device D1 calculates another length between the third part of the body (e.g. left shoulder of the body) and the fourth part of the body (e.g. left upper arm of the body) according to the second round trip time and the second transmission speed for constructing the three-dimensional body model.

In one embodiment, a sub sensor 133 is indirectly or directly electronically coupled to the sensor hub 122 by wires L2-L3 (or just by one wire), and the sub sensor 133 is placed at a fifth part of the body (e.g. left wrist of the body). The sensor hub 122 further transmits the first detecting signal to the sub sensor 133. Then, the sub sensor 133 transmits a fifth detecting signal back to the sensor hub 122 after the sub sensor 133 receiving the first detecting signal from the sensor hub 122. In another embodiment, the sub sensor 133 is electronically coupled to the sub sensor 132, and the sub sensor 132 is electronically coupled to the sensor hub 122. The sensor hub 122 firstly transmits the first detecting signal to the sub sensor 132, and then the sub sensor 132 transmits the received first detecting signal to the sub sensor 133. Then, the sub sensor 133 transmits the fifth detecting signal back to the sensor hub 122 through the sub sensor 132.

As such, the sensor hub 122 also can collect the round trip time (between sensor hub 122 and the sub sensor 133) and obtain a transmission speed of the second detecting signal. In the same way, the sensor hub 122 transmits this round trip time and this transmission speed to the electronic device D1 for calculating the length between the left wrist and the left shoulder of the body. The length can be applied for constructing the three-dimensional model of the human body.

In one embodiment, the sensor hub 121 and the sub sensor 131 are coupled by using a wire L1 with a plug-and-play function. The sensor hub 122 and the sub sensor 132 are coupled by using a wire L2 with the plug-and-play function. The wires having the plug-and-play function can be implemented as can-bus. The plug-and-play function is useful when the three-dimensional model construction system 100 needs to add more sub sensors or to remove sub sensors, the couple method with plug-and-play function can be easily adjusted for connecting to the newly added sub sensors or connecting to the two reconfigured sub sensors.

Besides, the sensor hub 121 transmits the first round trip time and the first transmission speed to the electronic device 01 by a wireless communication W1, and the sensor hub 122 transmits the second round trip time and the second transmission speed to the electronic device D1 by a second wireless communication W2. Similarly, the sensor hubs 123-125 also can separately transmit the transmission speed and the round trip time obtained by each one of themselves to the electronic device D1 by the corresponding wireless connections W3-W5. For example, the sensor hub 124 transmits the obtained transmission speed and the obtained round trip time to the electronic device D1 by the wireless connection W3. The sensor hub 125 transmits the obtained transmission speed and the obtained round trip time to the electronic device D1 by the wireless connection W5. Thus, the electronic device D1 can calculate each length of the limbs for constructing the three-dimensional human model. It should be noticed that the sensor hubs 121-125 can respectively transmit the information (e.g. the transmission speed and the round trip time obtained by each one of their own) to the electronic device D1, without interacting with each other.

In one embodiment, as shown in FIG. 3, the three-dimensional body model 20 can be displayed on the screen of the electronic device D1 in real-time after the electronic device D1 calculates each length of the limbs and constructs the three-dimensional human model. In one embodiment, the three-dimensional model construction system 100 can be applied for a rehabilitation program. For example, the electronic device D1 can also display a symbol 21 on the screen to give a hint for user. The symbol 21 indicates how to adjust the body movement (e.g. the hint indicates the user should lift the foot higher). As such, user can see the three-dimensional body model 20 of himself/herself in real time and then follow the symbol 21 to adjust his/her movement.

Therefore, through the three-dimensional model construction system and three-dimensional model construction method, the lengths of user's limbs can be precisely calculated for constructing the three-dimensional body model. And, the sensor hubs of the three-dimensional model construction system directly transmit information to the other electronic device. The sensor hubs do not need to connect to each other. In this way, the movement of the human body and the size of human body will not be limited by the wires or transmission issue between the sensor hubs. Besides, the sensor hubs and the sub sensors can be configured in a suit. It helps the users having different body shapes can easily wear the suit to construct the three-dimensional model. Therefore, the present invention provides a three-dimensional model construction system and method for precisely detecting the length of different parts of the human body, so as to construct the three-dimensional body model.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A three-dimensional model construction system, comprising:
a first sensor hub, placed at a first part of a body, for transmitting a first detecting signal; and
a first sub sensor, placed at a second part of the body, for transmitting a second detecting signal back to the first sensor hub in response to receiving the first detecting signal from the first sensor hub;
wherein the first sensor hub records a first round trip time of the first detecting signal and the second detecting signal, and the first round trip time is applied to calculate a length between the first part of the body and the second part of the body for constructing a three-dimensional body model.

2. The three-dimensional model construction system of claim 1, wherein the first sensor hub transmits the first round trip time and a first transmission speed to an electronic device, and a processor of the electronic device calculates the length between the first part of the body and the second part of the body according to the first round trip time and the first transmission speed;
wherein the first transmission speed is determined by the first sensor hub.

3. The three-dimensional model construction system of claim 2, wherein the processor of the electronic device multiplies the first round trip time by the first transmission speed to calculate the length between the first part of the body and the second part of the body.

4. The three-dimensional model construction system of claim 2, further comprising:
a second sensor hub, placed at a third part of the body, for transmitting a third detecting signal; and
a second sub sensor, placed at a fourth part of the body, for transmitting the fourth detecting signal back to the second sensor hub in response to receiving the third detecting signal from the second sensor hub;
wherein the second sensor hub records a second round trip time of the third detecting signal and the fourth detecting signal, and the second round trip time is applied to calculate a length between the third part of the body and the fourth part of the body.

5. The three-dimensional model construction system of claim 4, wherein the second sensor hub transmits the second round trip time and a second transmission speed to the electronic device, and the processor of the electronic device calculates another length between the third part of the body and the fourth part of the body according to the second round trip time and the second transmission speed for constructing the three-dimensional body model.

6. The three-dimensional model construction system of claim 4, wherein the first sensor hub and the first sub sensor are coupled by a first wire with a plug-and-play function, the second sensor hub and the second sub sensor are coupled by a second wire with the plug-and-play function; and
the first sensor hub transmits the first round trip time and the first transmission speed to the electronic device by a first wireless communication, and the second sensor hub transmits the second round trip time and the second transmission speed to the electronic device by a second wireless communication.

7. The three-dimensional model construction system of claim 1, further comprising:
a second sub sensor, electronically coupled to the first sub sensor, and the second sub sensor placed at a fifth part of the body;
wherein the first sensor hub further transmits the first detecting signal to the second sub sensor, and the second sub sensor transmits a fifth detecting signal back to the first sensor hub in response to the second sub sensor receiving the first detecting signal from the first sensor hub.

8. The three-dimensional model construction system of claim 1, wherein the first sensor hub and the first sub sensor are assembled in a wearable device or a suit.

9. The three-dimensional model construction system of claim 1, wherein the first sensor hub further comprising:
a detecting sensor, for detecting a movement of the first part of the body;
a power supply circuit, for providing a power to the first sub sensor; and
a transmission device, for transmitting and receiving the first detecting signal.

10. A three-dimensional model construction method, comprising:
transmitting a first detecting signal by a first sensor hub placed at a first part of a body; and
transmitting a second detecting signal back to the first sensor hub in response to receiving the first detecting signal from the first sensor hub by a first sub sensor placed at a second part of the body;
wherein the first sensor hub records a first round trip time of the first detecting signal and the second detecting signal, and the first round trip time is applied to calculate a length between the first part of the body and the second part of the body for constructing a three-dimensional body model.

11. The three-dimensional model construction method of claim 10, further comprising:
transmitting the first round trip time and a first transmission speed to an electronic device by the first sensor hub; and
calculating the length between the first part of the body and the second part of the body according to the first round trip time and the first transmission speed by a processor of the electronic device;
wherein the first transmission speed is determined by the first sensor hub.

12. The three-dimensional model construction method of claim 11, further comprising:
multiplying the first round trip time by the first transmission speed to calculate the length between the first part of the body and the second part of the body by the processor of the electronic device.

13. The three-dimensional model construction method of claim 11, further comprising:
transmitting a third detecting signal by a second sensor hub placed at a third part of the body; and
transmitting the fourth detecting signal back to the second sensor hub by a second sub sensor placed at a fourth part of the body in response to receiving the third detecting signal from the second sensor hub;
wherein the second sensor hub records a second round trip time of the third detecting signal and the fourth detecting signal, and the second round trip time is applied to calculate a length between the third part of the body and the fourth part of the body.

14. The three-dimensional model construction method of claim 13, further comprising:
transmitting the second round trip time and a second transmission speed to the electronic device by the second sensor hub; and
calculating another length between the third part of the body and the fourth part of the body by the processor of the electronic device according to the second round trip time and the second transmission speed for constructing the three-dimensional body model.

15. The three-dimensional model construction method of claim 13, wherein the first sensor hub and the first sub sensor are coupled by a first wire with a plug-and-play function, the second sensor hub and the second sub sensor are coupled by a second wire with the plug-and-play function; and the first sensor hub transmits the first round trip time and the first transmission speed to the electronic device by a first wireless communication, and the second sensor hub transmits the second round trip time and the second transmission speed to the electronic device by a second wireless communication.

16. The three-dimensional model construction method of claim 10, further comprising:
transmitting the first detecting signal to a second sub sensor by the first sensor hub; and
transmitting a fifth detecting signal back to the first sensor hub by the second sub sensor in response to the second sub sensor receiving the first detecting signal from the first sensor hub;
wherein the second sub sensor is electronically coupled to the first sub sensor, and the second sub sensor is placed at a fifth part of the body.

17. The three-dimensional model construction method of claim 10, wherein the first sensor hub and the first sub sensor are assembled in a wearable device or a suit.

18. The three-dimensional model construction method of claim 10, further comprising:
detecting a movement of h first part of the body by a detecting sensor of the first sensor hub;
providing a power to the first sub sensor by a power supply circuit of the first sensor hub; and
transmitting and receiving the first detecting signal by a transmission device of the first sensor hub.
